(19) United States
(12) Patent Application Publication
(10) Pub. No.: US 2011/0298379 A1
(43) Pub. Date: Dec. 8, 2011

(54) SYSTEM OF CONTROLLING PRODUCT DISPLAY LIGHTING

(75) Inventors: Jin Sun JUNG, Hwaseong-si (KR); Sang Kyeong YUN, Suwon-si (KR); Haeng Seok YANG, Bucheon-si (KR)

(73) Assignee: SAMSUNG LED CO., LTD., Suwon-si (KR)

(21) Appl. No.: 13/153,756

(22) Filed: Jun. 6, 2011

(30) Foreign Application Priority Data
Jun. 7, 2010 (KR) 10-2010-0053443

(51) Int. Cl. H05B 37/02; H04N 7/18; G06F 17/00

(52) U.S. Cl. 315/149; 235/375; 348/143; 315/291; 315/294; 348/E07.085

(57) ABSTRACT

There is provided a system of controlling product display lighting capable of controlling brightness levels and/or colors of illuminating light suitable for corresponding products according to characteristics of products, such as kinds or colors of products. The system of controlling product display lighting may include an information input unit acquiring information on products; a coordinator determining brightness levels and colors of illuminating light provided to the products according to the information on the products; a light source driver generating light source driving signals for outputting the determined brightness levels and colors of illuminating light in the coordinator; and a light source unit outputting illumination light having the brightness levels and colors of illuminating light determined in the coordinator by the light source driving signals.

### CROSS-REFERENCE TO RELATED APPLICATIONS

This application claims the priority of Korean Patent Application No. 2010-0053443 filed on Jun. 7, 2010, in the Korean Intellectual Property Office, the disclosure of which is incorporated herein by reference.

### BACKGROUND OF THE INVENTION

1. Field of the Invention

The present invention relates to a system of controlling product display lighting, and more particularly, to a system of controlling product display lighting capable of controlling brightness levels and/or colors of illuminating light suitable for corresponding products according to the characteristics of products, such as the categories or colors of products.

2. Description of the Related Art

Generally, shopping malls such as department stores, large retail outlets, or the like, have used lighting suitable to arouse a customer's interest in order to increase the sales of products. For example, a store selling a red meat (beef or pork, for instance) has used a red lighting in order to represent the color of meat as a scarlet color, a store selling fresh foods such as fruits and vegetables has used relatively bright lighting in order to demonstrate the freshness of the product, a store selling products such as precious metals has used very soft and warm lighting in order to emphasize the luxurious aspect of the product.

Meanwhile, in shopping malls, booths in which products are sold are frequently newly established or removed and the display position of the same products is frequently changed, such that lighting applied to products should be newly established or frequently moved.

However, if lighting is newly installed or moved according to the frequent change of the display position of products, additional material costs and labor costs can be generated.

Therefore, even though the position of the displayed products is changed, a need exists for a technology capable of providing lighting having appropriate color and brightness for products whose display position is changed while using the pre-installed lighting facilities as they are.

### SUMMARY OF THE INVENTION

As an aspect of the present invention provides a system of controlling product display lighting capable of controlling the brightness levels and/or colors of illuminating light suitable for corresponding products according to characteristics of products such as the categories or colors of products.

According to an aspect of the present invention, there is provided a system of controlling product display lighting, including: an information input unit acquiring information on products; a coordinator determining brightness levels and colors of illuminating light provided to the products according to the information on the products; a light source driver generating light source driving signals for outputting the determined brightness levels and colors of illuminating light in the coordinator; and a light source unit outputting illumination light having the brightness levels and colors of illuminating light determined in the coordinator by the light source driving signals.

The information input unit may include: a camera module generating color images of the products; a display unit displaying the color images of the products and providing them to the user; a user input unit receiving the information on the brightness levels and colors of illuminating light applied to the products from a user referring to the displayed color images; and a radio communication module transmitting the information of brightness levels and colors input from the user input unit to the coordinator as the product information.

The coordinator may include: a radio communication module receiving the information of brightness levels and colors received from the user input unit; and a lighting controller determining the brightness levels and colors of illumination light output from the light source unit according to the information on the brightness levels and colors received from the user input unit.

The information input unit may include: a camera module generating the color images of the products; and a radio communication module transmitting the color images of the products to the coordinator as the product information.

The coordinator may include: a radio communication module receiving the color images of the products; an image analyzer analyzing the color images of the products to generate the information on the brightness levels and colors of illuminating light to be provided to the products; and a lighting controller determining the brightness levels and colors of illumination light output from the light source unit according to the information on the brightness levels and colors of illuminating light generated from the image analyzer.

The information input unit may include: an RFID reader or a barcode reader reading RFIDs or barcodes applied to the products to acquire the information on the products; and a radio communication module transmitting the information on the products acquired from the read RFID or barcode to the coordinator.

The coordinator may include: a radio communication module receiving the information on the products; an image analyzer analyzing the information on the products to generate the information on the brightness levels and colors of illuminating light to be applied to the products; and a lighting controller determining the brightness levels and colors of illuminating light output from the light source unit according to the information on the brightness levels and colors of illuminating light generated from the image analyzer.

The light source unit may include at least one red LED, at least one green LED, and at least one blue LED, and the light source driver may include a red LED driving circuit for driving the at least one red LED, a green LED driving circuit for driving the at least one green LED, and a blue LED driving circuit for driving the at least one blue LED.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block configuration diagram showing a system of controlling product display lighting according to an exemplary embodiment of the present invention;

FIG. 2 is a block configuration diagram showing in detail an information input unit applied to the system of controlling product display lighting according to the exemplary embodiment of the present invention;

FIG. 3 is a block configuration diagram showing in detail a coordinator applied to the system of controlling product display lighting according to the exemplary embodiment of the present invention; and

FIG. 4 is a block configuration diagram showing in detail a light source driver and a light source unit applied to the system of controlling product display lighting according to the exemplary embodiment of the present invention.

### DETAILED DESCRIPTION OF THE PREFERRED EMBODIMENT

Hereinafter, various exemplary embodiments of the present invention will be described in detail with reference to the accompanying drawings. However, the exemplary embodiments of the present invention may be modified in many different forms and the scope of the invention should not be limited to the embodiments set forth herein. Rather, these exemplary embodiments are provided so that this disclosure will be thorough and complete, and will fully convey the concept of the invention to those skilled in the art. Therefore, it is to be noted that the shape and size of components shown in the drawings can be exaggerated in order to provide more clear description.

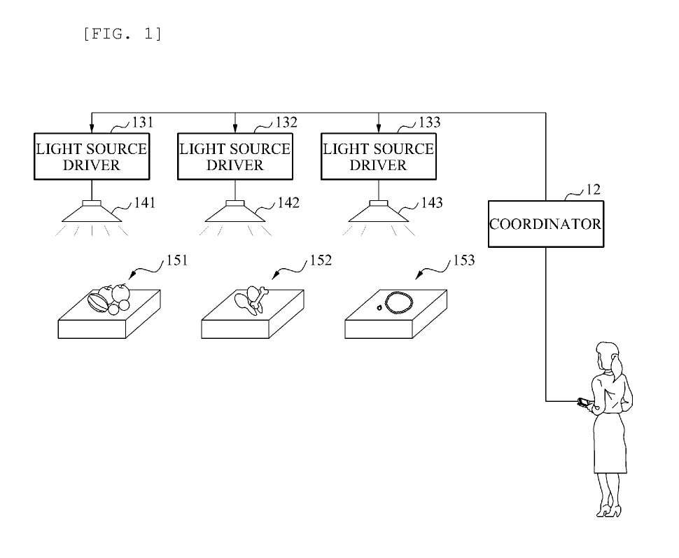

FIG. 1 is a block configuration diagram showing a system of controlling product display lighting according to an exemplary embodiment of the present invention.

As shown in FIG. 1, a system of controlling product display lighting according to an exemplary embodiment of the present invention may be configured to include: an information input unit 11, a coordinator 12, a light source driver 133, and a light source unit 143.

The information input unit 11 can acquire information on products 151 to 153 to which lighting will be provided. The information input unit 11 acquires product information such as colors or kinds of products, or the like, in various manners and transmits them to the coordinator 12.

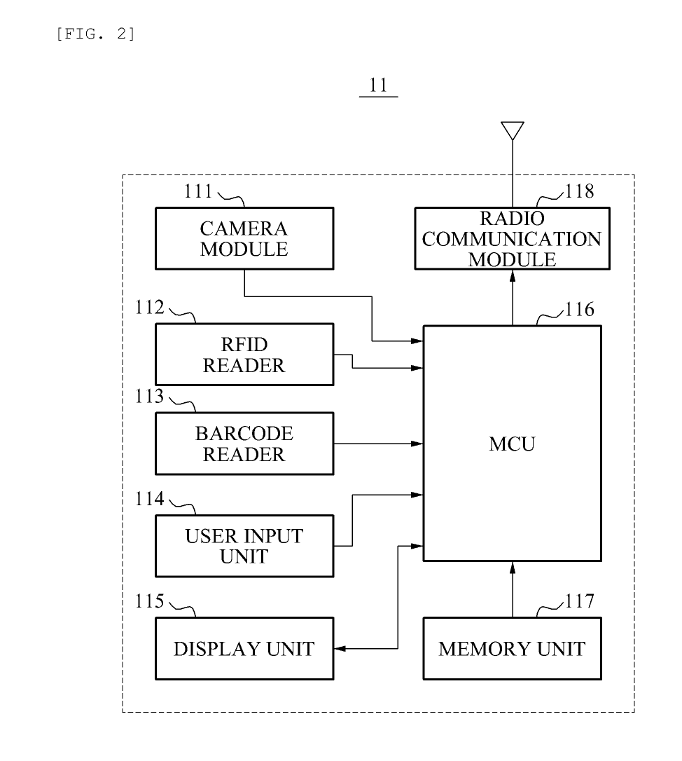

FIG. 2 is a block configuration diagram showing in detail an information input unit applied to the system of controlling product display lighting according to the exemplary embodiment of the present invention.

As shown in FIG. 2, the input information unit 11 may be configured to include: at least one of a camera module 111, an RFID reader 112, and a barcode reader 113 that are units receiving product information, a user input unit 114 enabling the user to input information, a display unit 115 displaying visual information on products, a memory unit 117 storing lighting information on products, a radio communication module 118 communicating with the coordinator, and an MCU 116 appropriately controlling the above-mentioned components.

The coordinator 12 may determine the brightness levels and colors of illuminating light applied to the products according to the product information. The coordinator 12 receives the product information transmitted from the information input unit 11, determines the brightness levels and colors of illuminating light output from the light source units 141 to 143 by using the input product information, and outputs light source controlling signals including the determined information.

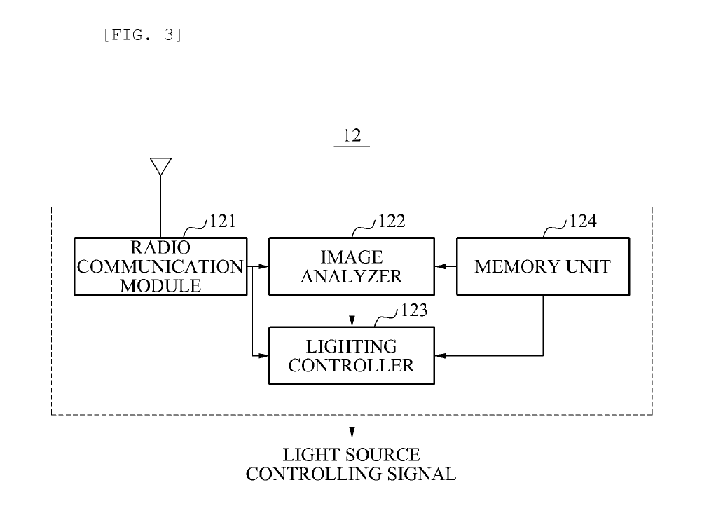

FIG. 3 is a block configuration diagram showing in detail a coordinator applied to the system of controlling product display lighting according to the exemplary embodiment of the present invention.

As shown in FIG. 3, according to the exemplary embodiment of the present invention, the coordinator 12 may be configured to include a radio communication module 121 receiving the product information through radio communication with the information input unit 11, when the product information received from the information input unit 11 is the color images of the products, an image analyzer 122 analyzing the color images of the products, and a lighting controller 123 determining the magnitude in brightness levels and colors output from the light source according to the results of analyzing the product information received in the information input unit 11 or the color images received in the image analyzer 122 and outputting them to as the light source controlling signals. The coordinator 12 may further include a memory unit 124 in which information applied to the image analysis performed in the image analyzer 122 or information required to generate the light source controlling signals performed in the lighting controller 123 are recorded.

The light source drivers 131 to 133 generate driving signals for driving the light source unit 142. For example, the drivers 131 to 133 generate the driving voltage and/or the driving current for driving the light source unit 142 and provide them to the light source unit 142. The coordinator 12 generates the light source controlling signals that can determine the brightness levels and colors of illuminating light to be output from the light source and output them. For example, when the light source drivers 131 to 133 are a driving circuit using a PWM manner, the light source controlling signal may output information on a pulse duty of a PWM control to output the determined brightness levels and colors of the illuminating light and the light source drivers 131 to 133 may output the driving voltage or the driving current that are directly provided to the light source unit 142 according to the pulse duty control.

The light source units 141 to 143 are light sources capable of controlling the brightness levels and colors thereof, which may be, for example, a light source implemented with red, green, and blue LEDs.

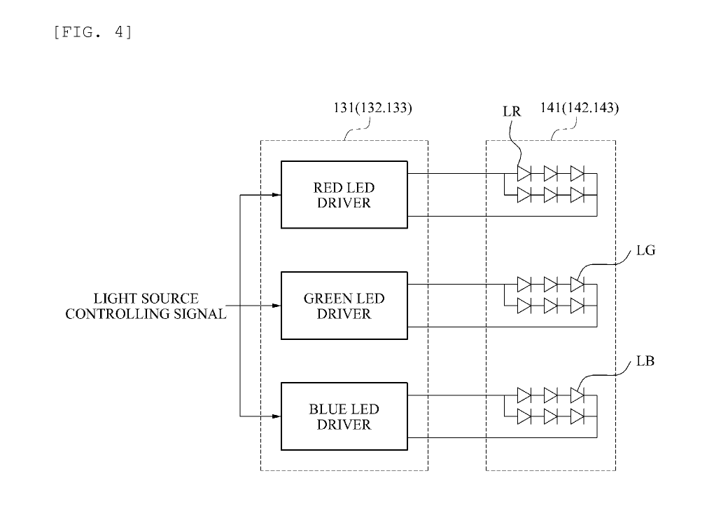

FIG. 4 is a block configuration diagram showing in detail a light source driver and a light source unit applied to the system of controlling product display lighting according to the exemplary embodiment of the present invention.

As shown in FIG. 4, the light source units 141 to 143 may be implemented with a plurality of LEDs including at least one of red, green, and blue LEDs (LR, LG, and LB). The 3-color LEDs (LR, LG, and LB) adjust the output of each color, thereby making it possible to freely control the mixed brightness levels and colors of illuminating light. Therefore, each light source driver 131 to 133 may include a red LED driver, a green LED driver, and a blue LED driver generating the driving signals for the LEDs of each color in order that the 3-color LEDs (LR, LG, and LB) are individually driven.

Hereinafter, the operations of various exemplary embodiments of the present invention will be described.

First, a first exemplary embodiment of the present invention will be described with reference to FIGS. 1 to 4.

The first exemplary embodiment of the present invention generates color images of products to which lighting will be provided and sets the user desired lighting for the color images in the information input unit 11, thereby making it possible to implement the type applying lighting.

In more detail, the user photographs products 151 to 153 to which lighting will be provided by using the camera module 111 included in the information input unit 11 (for example, PDA) to generate the color images of the products. The color images generated by the camera module 111 are transmitted to the MCU 116, wherein the MCU 116 properly performs the color image processing as needed and then, transfers the processed color images to the display unit 115 and the display unit 115 displays the color images to be visually recognized by the user.

Thereafter, the user can visually recognize the color images of the products displayed on the display unit 115 and then, input the information on the proper brightness levels and colors of illuminating light using the user input unit 114 such as a keypad. During the processing, the user selects the lighting information previously stored in the memory unit 117 through the operation of the user input unit 114 and applies the lighting information to the color images of the products, thereby making it possible to preview the products in the state in which lighting is changed. When the user completes the selection for the most appropriate brightness levels and colors of illuminating light by applying several lighting information stored in the memory unit 117 to the color images of the products, the information on the colors and brightness levels of illuminating light selected by the user is wirelessly transmitted to the coordinator 12 through the radio communication module 118.

The coordinator 12 can receive the information on the brightness levels and colors of illuminating light selected by the user through the radio communication module 121 and transmit them to the lighting controller 123. The lighting controller 123 may output the control signals for controlling the light source so that the illuminating light may be output from the light source according to the information on the brightness levels and colors of illuminating light selected by the user. The control values for controlling the light source corresponding to the information on the brightness levels and colors of illuminating light set by the user may be stored in the memory unit 124 included in the coordinator 12. The lighting controller 123 may read the light source controlling values corresponding to the input brightness levels and color values set by the user from the memory and then, transfer them to the light source driver in the type of the control signals.

Then, the light source drivers 131 to 133 output the driving signals for actually driving the light source according to the transferred light source controlling signals and transfer them to the light source. As described above, when the light source units 141 to 143 are configured to include the red LED (LR), the green LED (LG), and the blue LED (LB), the light source drivers 131 to 133 may include the drivers for driving the LEDs for each color and the driving signals output from the LED drivers for each color may be the driving current for driving the LEDs for each color. In addition, when the light source drivers 131 to 133 are implemented as the driving circuit to which the PWM control manner is applied, the light source controlling signals output from the coordinator 12 may be a signal for determining the duty of the PWM control pulse that is made in the LED drivers for each color.

Unlike the above-mentioned first exemplary embodiment, in a second exemplary embodiment of the present invention, the user uses the information input unit 11 to generate the color images of the products and then, immediately transmit them to the coordinator 12 without the user performing the selection process. That is, the user photographs the products by using the camera module 111 to generate the color images of the products and transmits the generated color images to the coordinator 12 via the radio communication module 118 through the MCU 116.

The coordinator 12 receives the color images through the radio communication module 121 and the radio communication module 121 transfers the received color images to an image analyzer 122. The image analyzer 122 analyzes the colors or the shapes of the products included in the color images and determines the brightness levels and colors of illuminating light suitable for the products according to the analyzed results. For example, the image analyzer 122 mutually compares the information on the colors and shape of the products previously stored in the memory unit 124 with the information on the colors and shapes of the products included in the color images to determine the products to which the lighting will be provided and determines the information on the brightness levels and colors of illuminating light corresponding to the products determined from the memory unit 124 previously storing the information on the brightness levels of illuminating light suitable for the products.

The lighting controller 123 may output the control signals for controlling the light source so that the illumination light may be output from the light source according to the information on the brightness levels and colors of illuminating light output from the image analyzer 122. As in the foregoing first exemplary embodiment, the control values for controlling the light source corresponding to the information on the brightness levels and colors of illuminating light set by the user may be stored in the memory unit 124. The lighting controller 123 may read the light source controlling values corresponding to the input brightness levels and color values set by the user from the memory unit 124 and then, transfer them to the light source driver in the type of the light source controlling signals.

The operations of the light source drivers 131 to 133 and the light source units 141 to 143 are substantially the same as the foregoing first exemplary embodiment and therefore, a description of the overlapping portions will not be repeated.

The third exemplary embodiment of the present invention may acquire the information on the products to which lighting will be provided in a type other than the color images and transmit it to the coordinator.

In the third exemplary embodiment of the present invention, the user uses the information input unit 11 to read RFID tags or barcodes attached or printed to the products or the packages of the products to which lighting will be provided, thereby making it possible to acquire the product information. To this end, the information input unit 11 may include an RFID reader 112 or a barcode reader 113. The RFID reader 112 or the barcode reader 113 of the information input unit 11 reads the RFID tags or the barcodes including the product information to read the product information to which lighting will be provided (for example, various product information previously input to the RFID tags or the barcodes such as the kinds of products, the colors of products, or the like). The product information read from the RFID reader 112 or the barcode reader 113 is transferred to the coordinator 12 through the radio communication module through the MCU 116.

The coordinator 12 receives the product information through the radio communication module 121 and the radio communication module 121 transfers the product information to the lighting controller 123. The memory unit 124 may previously store the information on the brightness levels and colors of illuminating light corresponding to the product information and the lighting controller 123 reads the information on the brightness levels and colors of illuminating light corresponding to the product information from the memory unit 124, thereby making it possible to output the light source controlling signals including the information on the brightness levels and colors of illuminating light suitable for the corresponding products.

The operations of the light source drivers 131 to 133 and the light source units 141 to 143 are substantially the same as the foregoing first exemplary embodiment and therefore, a description of the overlapping portions will not be repeated.

As set forth above, the present invention can simply change the brightness levels and colors of illuminating light suitable for the changed products according to the change in the displayed products. In addition, the present invention can control the lighting with the previously set brightness levels and colors and enable the user to directly determine the desired brightness levels and colors of illuminating light, without the user's subjective intervention.

While the present invention has been shown and described in connection with the exemplary embodiments, it will be apparent to those skilled in the art that modifications and variations can be made without departing from the spirit and scope of the invention as defined by the appended claims.

What is claimed is:

1. A system of controlling product display lighting, comprising:
an information input unit acquiring information on products;
a coordinator determining brightness levels and colors of illuminating light provided to the products according to the information on the products;
a light source driver generating light source driving signals for outputting the determined brightness levels and colors of illuminating light in the coordinator; and
a light source unit outputting illumination light having the brightness levels and colors of illuminating light determined in the coordinator by the light source driving signals.

2. The system of controlling product display lighting according to claim 1, wherein the information input unit includes:
a camera module generating color images of the products;
a display unit displaying the color images of the products and providing them to the user;
a user input unit receiving the information on the brightness levels and colors of illuminating light applied to the products from a user referring to the displayed color images; and
a radio communication module transmitting the information of brightness levels and colors input from the user input unit to the coordinator as the product information.

3. The system of controlling product display lighting according to claim 2, wherein the coordinator includes:
a radio communication module receiving the information of brightness levels and colors received from the user input unit; and
a lighting controller determining the brightness levels and colors of illumination light output from the light source unit according to the information on the brightness levels and colors received from the user input unit.

4. The system of controlling product display lighting according to claim 1, wherein the information input unit includes:
a camera module generating the color images of the products; and
a radio communication module transmitting the color images of the products to the coordinator as the product information.

5. The system of controlling product display lighting according to claim 4, wherein the coordinator includes:
a radio communication module receiving the color images of the products;
an image analyzer analyzing the color images of the products to generate the information on the brightness levels and colors of illuminating light to be provided to the products; and
a lighting controller determining the brightness levels and colors of illumination light output from the light source unit according to the information on the brightness levels and colors of illuminating light generated from the image analyzer.

6. The system of controlling product display lighting according to claim 1, wherein the information input unit includes:
an RFID reader or a barcode reader reading RFIDs or barcodes applied to the products to acquire the information on the products; and
a radio communication module transmitting the information on the products acquired from the read RFID or barcode to the coordinator.

7. The system of controlling product display lighting according to claim 6, wherein the coordinator includes:
a radio communication module receiving the information on the products;
an image analyzer analyzing the information on the products to generate the information on the brightness levels and colors of illuminating light to be applied to the products; and
a lighting controller determining the brightness levels and colors of illuminating light output from the light source unit according to the information on the brightness levels and colors of illuminating light generated from the image analyzer.

8. The system of controlling product display lighting according to claim 1, wherein the light source unit includes at least one red LED, at least one green LED, and at least one blue LED, and
the light source driver includes a red LED driving circuit for driving the at least one red LED, a green LED driving circuit for driving the at least one green LED, and a blue LED driving circuit for driving the at least one blue LED.
